(19) United States
(12) Patent Application Publication
(10) Pub. No.: US 2011/0317563 A1
(43) Pub. Date: Dec. 29, 2011

(54) COMMUNICATION DEVICE AND RESOURCE REALLOCATION METHOD IN RADIO COMMUNICATIONS SYSTEM

(75) Inventors: Naoto Ishii, Tokyo (JP); Takahiro Nobukiyo, Tokyo (JP)

(73) Assignee: NEC CORPORATION, Tokyo (JP)

(21) Appl. No.: 13/254,687

(22) PCT Filed: Feb. 8, 2010
(86) PCT No.: PCT/JP2010/000731

§ 371 Date: Sep. 2, 2011

(30) Foreign Application Priority Data
Mar. 3, 2009 (JP) 2009-048964

(51) Int. Cl. H04W 72/04; H04W 24/00

(52) U.S. Cl. 370/241; 370/329

(57) ABSTRACT

A resource reallocation method that can suppress variations in reception delay time in reservation-type scheduling and a communication device using the method are provided. In a radio communications system in which a radio resource is reserved to periodically perform a communication between communication devices, the number of retransmissions of a packet transmitted to a communication device using the reserved radio resource (Step S201) is measured (Step S203), and reallocation of a radio resource to be used for the communication is performed depending on the number of retransmissions (Steps S204 and S205).

### TECHNICAL FIELD

The present invention relates to a radio communications system and, more particularly, to a resource reallocation method and a communication device using the method.

### BACKGROUND ART

In LTE (Long Term Evolution) systems, which have been currently being standardized in 3GPP (3rd Generation Partnership Project), a system bandwidth assigned to a base station is divided into small frequency bandwidths called resource blocks, and a resource block is used as a unit of allocation for scheduling.

For scheduling of those applications that have inconstant period of data occurrence such as web page browsing and file transfer, dynamic scheduling DS is employed. In the dynamic scheduling DS, it is possible to change radio resources (resource block, transmission period, transmission power, and the like) used for each transmission depending on the communication channel quality at the receiving side, but it is necessary to use a control channel other than a data channel to make a notification about which radio resource is used for each transmission.

On the other hand, for scheduling schemes for those traffics where data occur periodically such as VoIP (Voice over Internet Protocol), a reservation-type scheduling scheme called persistent scheduling PS has been proposed (for example, see NPL 1). The reservation-type scheduling is a scheduling scheme in which the radio resource used for an initially transmitted packet is reserved for the following packets, utilizing the constant periodicity of data occurrence as in VoIP and the like.

In the persistent scheduling PS, since the radio resource for an initially transmitted packet is reserved, a notification using a control channel is not required. Accordingly, the radio resources allocated to control channels can be reduced, and the efficiency of frequency usage can be increased. Moreover, in a case where the sending side reserves a resource, the following allocation is generally considered: performing the resource allocation by referring to the average communication channel quality of the system bandwidth; determining the frequency bandwidth and the coding rate of an error correction code; and allocating resources in order, beginning with a resource block that has not been reserved yet.

Incidentally, as a method for improving the transmission throughput, a technique has been disclosed in which MCS (Modulation and channel Coding Scheme) number used for a user device of interest is reduced when the number of retransmissions becomes greater than a predetermined value (see PTL 1, page 8, paragraph 0036).

### CITATION LIST

### Patent Literature

### [PTL 1]

Japanese Patent Application Unexamined Publication No. 2008-193439

### Non Patent Literature

### [NPL 1]

3GPP TS36.300 V8.5.0 (2008-05)3GPP E-UTRA and E-UTRAN Overall description, P. 62-63

### SUMMARY OF INVENTION

### Technical Problem

However, in reservation-type scheduling such as the persistent scheduling PS, since packets are transmitted at constant periods in accordance with the period of data occurrence of an initially transmitted packet, fluctuations over time in each resource block used for transmission are not sufficiently considered. However, such a system that a terminal reports the downlink communication channel quality in the form of an average for each resource block causes the overuse of uplink resources. Accordingly, it is supposed for a terminal to report the average communication channel quality throughout the system bandwidth.

Therefore, when the reception quality is deteriorated due to fading and interference from neighboring cells, the frequency of retransmissions is increased, and the delay time is increased. Moreover, if the number of retransmissions changes due to variations over time in communication channel quality, the period of time taken to complete the receipt of a packet varies with each packet. Accordingly, even if a packet is transmitted at constant periods on the sending side, the period of time taken to normally receive a packet varies on the receiving side.

Furthermore, the method disclosed in PTL 1 is to temporarily change the combination of a data modulation method and channel coding indicated by MCS depending on the number of retransmissions and therefore cannot sufficiently suppress variations in time period taken to complete the receipt of a packet on the receiving side.

Accordingly, an object of the present invention is to provide a resource reallocation method that can suppress variations in reception delay time in reservation-type scheduling, as well as a communication device using the method.

### Solution to Problem

A resource reallocation method in a radio communications system in which a radio resource is reserved to periodically perform a communication between communication devices, is characterized by comprising: measuring number of retransmissions of a packet transmitted to a communication device using a reserved radio resource; and performing reallocation of a radio resource to be used for the communication depending on the number of retransmissions.

A communication device according to the present invention is a communication device in a radio communications system that reserves a radio resource to periodically perform a communication with a different communication device, characterized by comprising: retransmission frequency measurement means for measuring number of retransmissions of a packet transmitted to the different communication device using a reserved radio resource; and resource reallocation means for performing reallocation of a radio resource to be used for the communication depending on the number of retransmissions.

A radio communications system according to the present invention is a radio communications system including at least one base station and at least one mobile terminal wherein a radio resource is reserved to periodically perform a communication between a base station and a mobile terminal, characterized in that the base station comprises: retransmission frequency measurement means for measuring the number of retransmissions of a packet transmitted to each mobile terminal using a reserved radio resource; and resource reallocation means for performing reallocation of a radio resource to be used for the communication depending on the number of retransmissions.

A computer program according to the present invention is a computer program for causing a program-controlled processor to function as a communication device in a radio communications system that reserves a radio resource to periodically perform a communication with a different communication device, characterized by causing the program-controlled processor to implement the functions of: measuring the number of retransmissions of a packet transmitted to the different communication device using the reserved radio resource; and performing reallocation of a radio resource to be used for the communication depending on the number of retransmissions.

### Advantageous Effects of Invention

According to the present invention, it is possible to suppress variations in reception delay time in reservation-type scheduling.

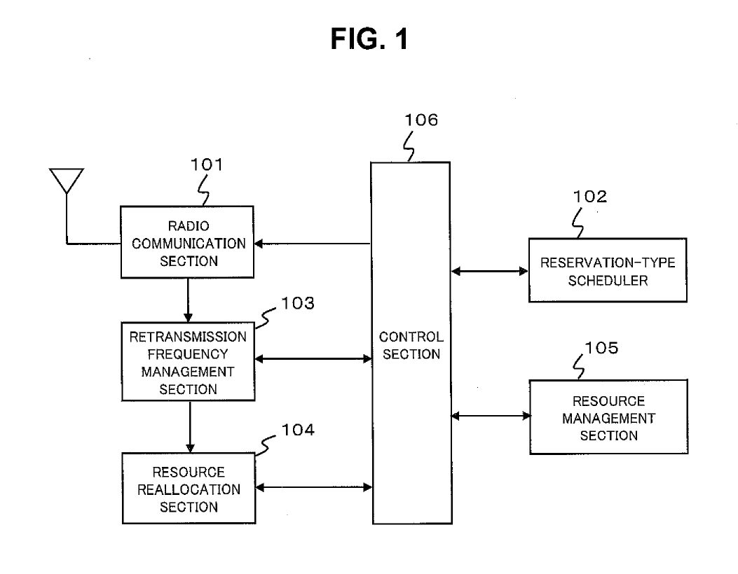

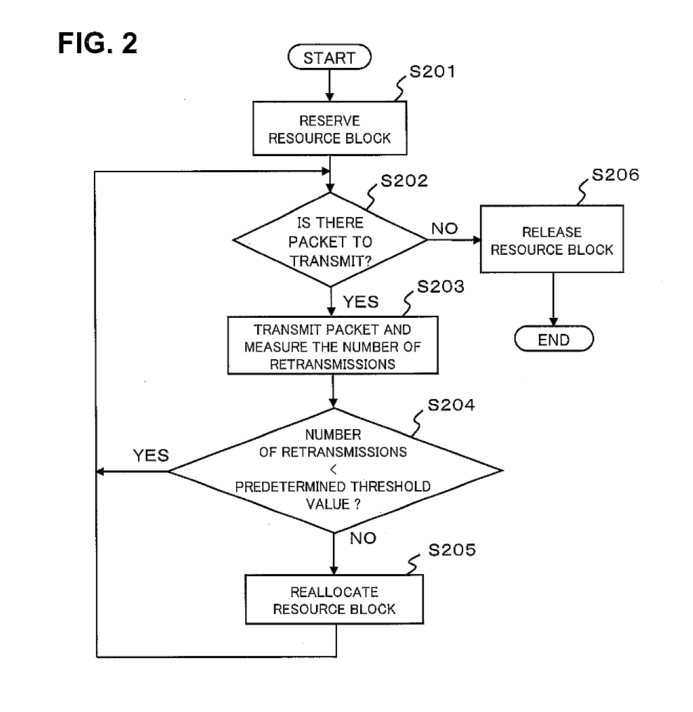

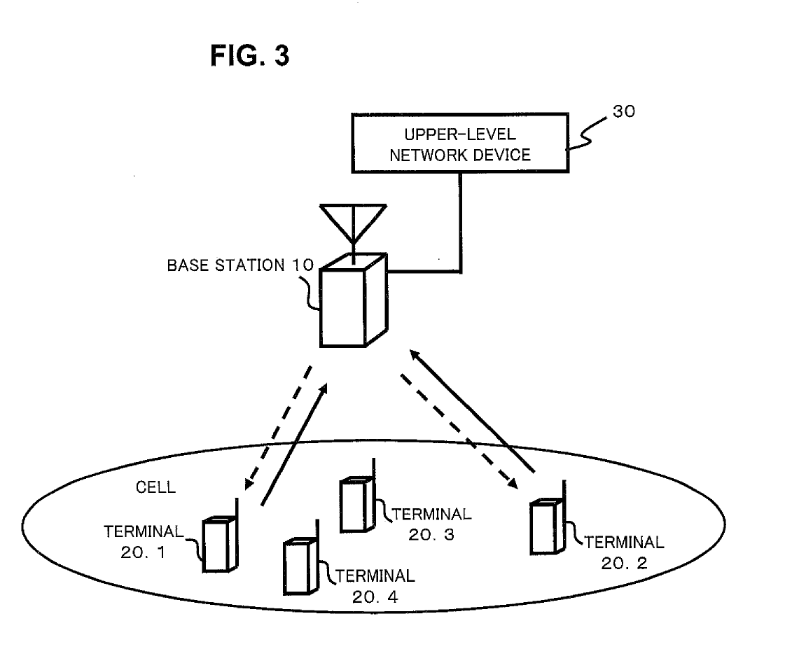

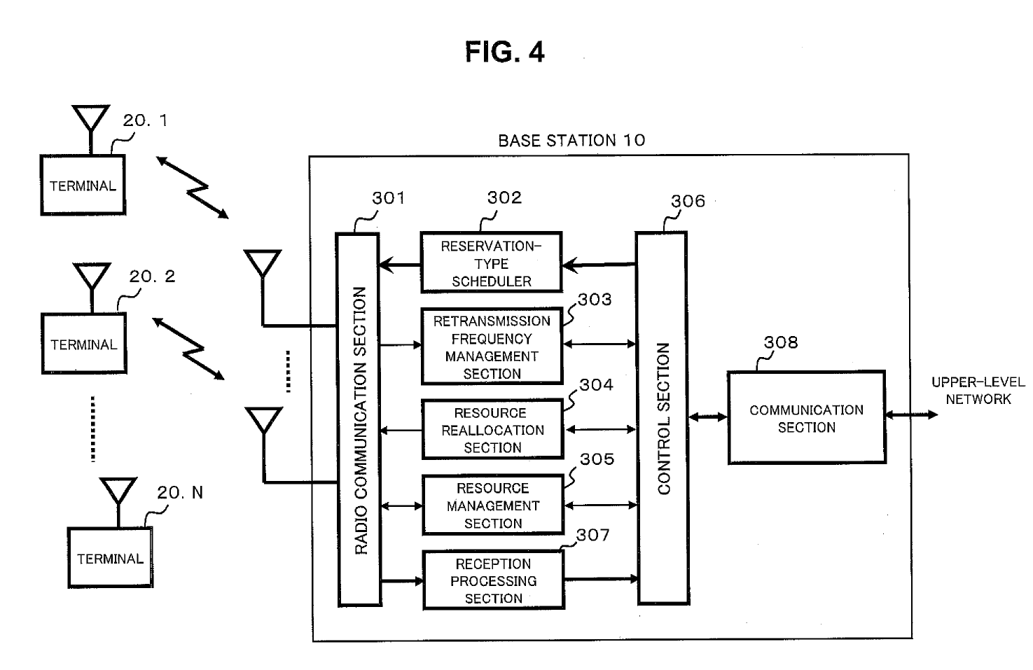

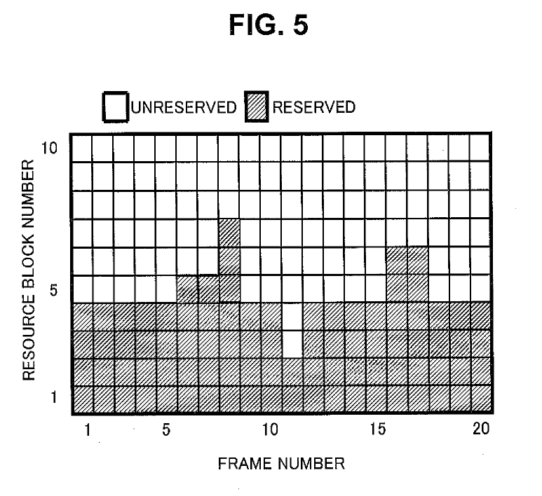

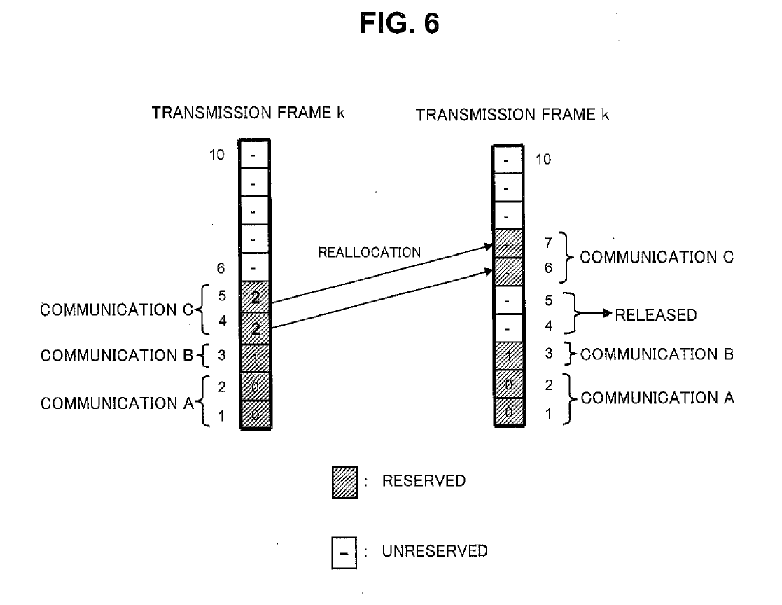

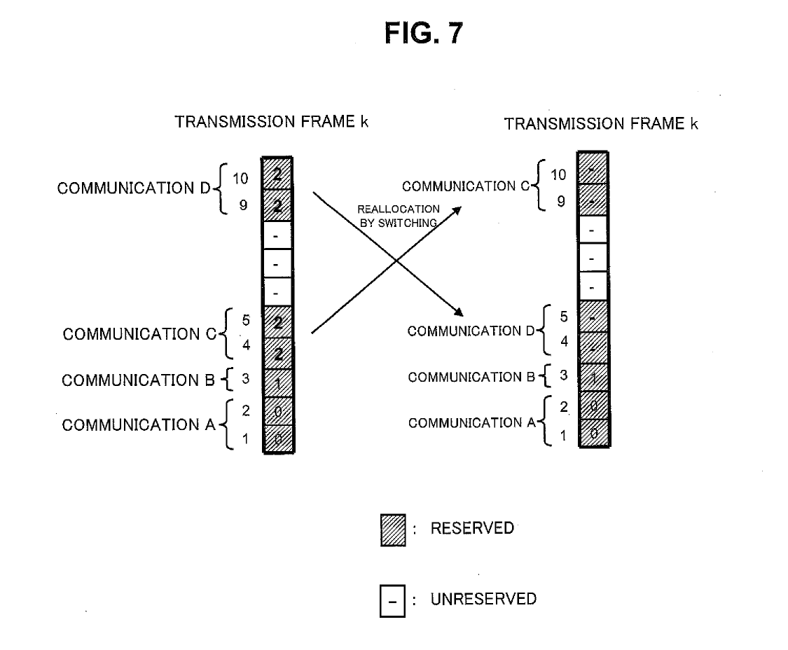

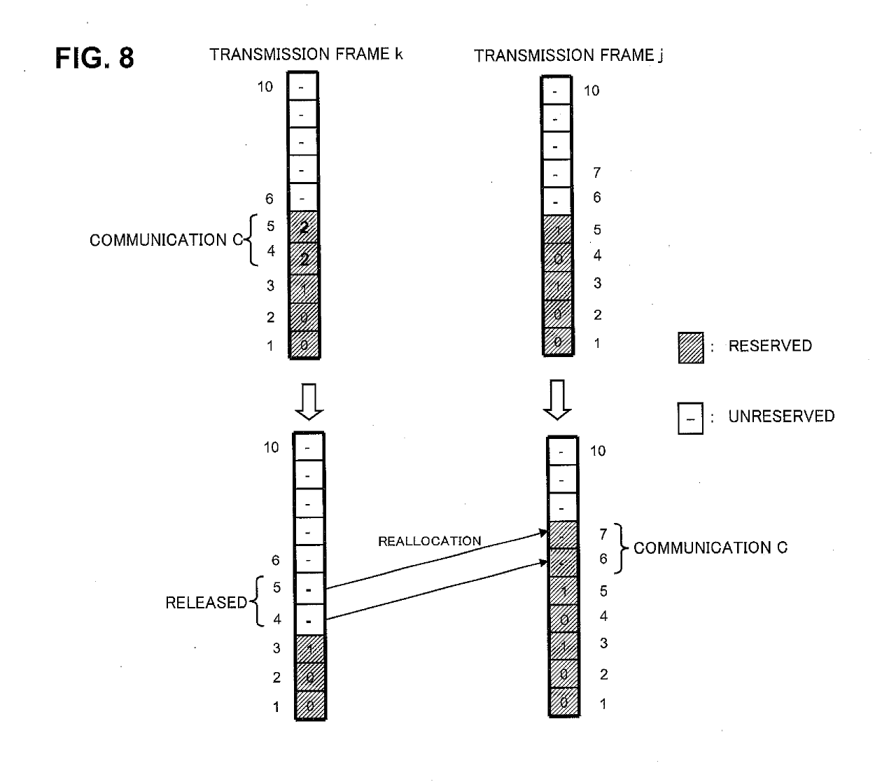

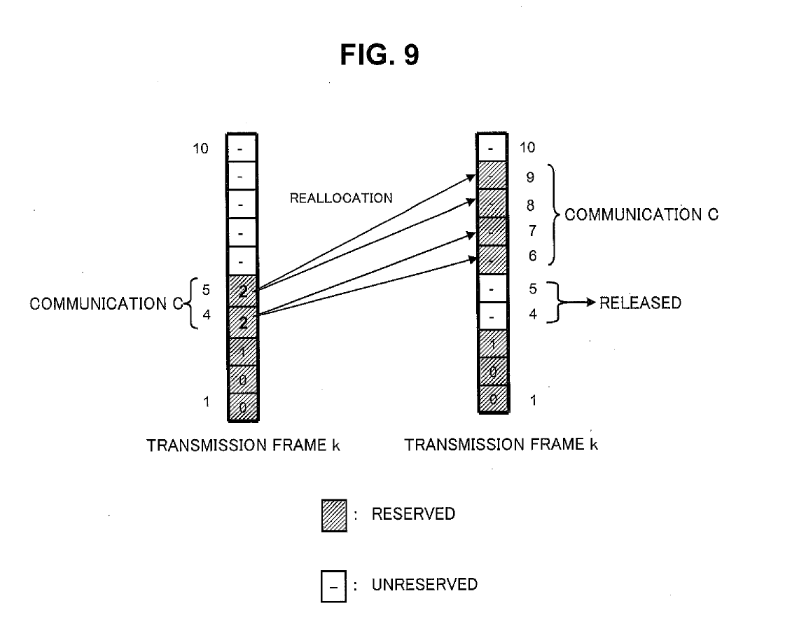

### BRIEF DESCRIPTION OF DRAWINGS

[FIG. 1] FIG. 1 is a block diagram schematically showing a configuration related to resource reallocation of a communication device according to a first exemplary embodiment of the present invention.

[FIG. 2] FIG. 2 is a flowchart showing a resource reallocation method in the communication device according to the present exemplary embodiment.

[FIG. 3] FIG. 3 is a block diagram showing a structure of a mobile communications system including a plurality of mobile stations and a base station to which a communication device according to a second exemplary embodiment of the present invention is applied.

[FIG. 4] FIG. 4 is a schematic block diagram showing an example of the configuration of the base station to which the communication device according to the second exemplary embodiment of the present invention is applied.

[FIG. 5] FIG. 5 is a resource structure diagram showing the reservation state of resource blocks used in reservation-type scheduling in the second exemplary embodiment.

[FIG. 6] FIG. 6 is a schematic frame resource structure diagram to describe a resource reallocation method according to a first example of the present invention.

[FIG. 7] FIG. 7 is a schematic frame resource structure diagram to describe a resource reallocation method according to a second example of the present invention.

[FIG. 8] FIG. 8 is a schematic frame resource structure diagram to describe a resource reallocation method according to a third example of the present invention.

[FIG. 9] FIG. 9 is a schematic frame resource structure diagram to describe a resource reallocation method according to a fourth example of the present invention.

### DESCRIPTION OF EMBODIMENTS

### 1. First Exemplary Embodiment

### 1.1) Configuration

Referring to FIG. 1, a radio communication section 101 is a collective block including a transmission section, a reception section, a channel control section, and the like of a general radio communications system and is assumed to have retransmission functionality and the like such as hybrid ARQ (Automatic Repeat reQuest).

A reservation-type scheduler 102 has a function of allocating radio resources to reservation-type traffic packets. A retransmission frequency management section 103 manages the number of retransmissions of each packet transmitted by the radio communication section 101. A resource reallocation section 104 performs reallocation of a reserved resource block depending on the number of retransmissions. A resource management section 105 has a function of managing the reservation state of resource blocks, which are units of allocation in a radio bandwidth. A control section 106 controls operation of the entire communication device. However, only resource reallocation control will be described here.

### 1.2) Operation

As shown in FIG. 2, upon arrival of a packet periodically occurring like that of VoIP, the control section 106 causes the reservation-type scheduler 102 to reserve a resource block (Step S201). Specifically, the reservation-type scheduler 102 checks on the resource reservation state of the resource management section 105, reserves a resource block at constant periods, updates the reservation state at the resource management section 105, and notifies the result of allocation of the resource block to the control section 106. Note that the details of reservation operation will be omitted because the method of reserving a resource block of an initial packet is well known.

The control section 106 determines whether or not there is a packet for transmission (Step S202) and, when there is a packet for transmission (Step S202: YES), causes the radio communication section 101 to transmit this packet for transmission by using the resource block reserved by the reservation-type scheduler 102. In this event, the retransmission frequency management section 103, under the control of the control section 106, counts the number of retransmissions if this packet for transmission is a retransmitted one (Step S203). That is, for each reserved resource block, the retransmission frequency management section 103 manages the number of retransmissions of a packet transmitted.

The control section 106 and the resource reallocation section 104 perform resource block reallocation control depending on the number of retransmissions. Specifically, it is determined whether or not the number of retransmissions is smaller than a predetermined threshold value (Step S204). When the number of retransmissions is smaller than the predetermined threshold value (Step S204: YES), resource block reallocation is not performed, and the process returns to Step S202 for checking whether or not there is a packet for next transmission. If the number of retransmissions is not smaller than the predetermined threshold value (Step S204: NO), the resource reallocation section 104 reallocates a resource block to be used for the communication in question, that is, changes frequency bandwidths and/or changes transmission timings (Step S205). The resource reallocation section 104, as will be described later, allocates another available resource block (a resource block unreserved or exchangeable) as the resource block for use based on the reservation state of resource blocks managed by the resource management section 105 and then updates the reservation state at the resource management section 105. Thereafter, under the control of the control section 106, if there is a packet for next transmission (Step S202: YES), the radio communication section 101 performs packet transmission for the communication in question by using the reallocated resource block (Step S203). The above-described processing S202 to S205 is repeated as long as there is data to transmit using the reserved resource block.

When there is no packet for transmission (Step S202: NO), the control section 106 updates the reservation state at the resource management section 105 so that the reserved resource block will be released (Step S206).

Note that the resource reallocation functions of the reservation-type scheduler 102, retransmission frequency management section 103, resource reallocation section 104, resource management section 105, and control section 106 as described above can also be implemented similarly by executing computer programs on a program-controlled processor such as a CPU.

### 1.3) Effects

As described above, according to the present exemplary embodiment, the number of retransmissions is measured for each resource block reserved and allocated, and reallocation of a resource block is performed depending on the number of retransmissions. Preferably, when a retransmission is frequently made (when the number of retransmissions becomes not smaller than the predetermined number of times), the resource block for use is changed to another available resource block (resource reallocation). This resource reallocation operation makes it possible to reduce the delay time of a packet and to suppress variations thereof in the reservation-type scheduling scheme. Moreover, there is also an effect that a reduction in the number of retransmissions results in an increase in the radio resources that can be reserved, increasing the efficiency of radio resource usage.

### 2. Second Exemplary Embodiment

In a mobile communications system shown in FIG. 3, it is assumed, to avoid complicating description, that a plurality of mobile terminals 20.1 to 20.4 are located within a cell of a base station 10, which is connected to a upper-level network device 30. Hereinafter, a configuration of the base station 10 will be described with reference to FIGS. 4 and 5.

Referring to FIG. 4, the base station 10 includes, in addition to a radio communication section 301 for performing radio communication with the mobile terminals, a reservation-type scheduler 302, a retransmission frequency management section 303, a resource reallocation section 304, a resource management section 305, and a control section 306. The base station 10 further includes a reception processing section 307 for processing an uplink signal received from each mobile terminal and a communication section 308 that transmits transfer data in those uplink signals to the upper-level network device (base station control device) and also receives data from the upper-level network device.

Note that the respective functions of the reservation-type scheduler 302, retransmission frequency management section 303, resource reallocation section 304, resource management section 305, control section 306, and reception processing section 307 can also be implemented by executing corresponding computer programs on a program-controlled processor such as a CPU. In addition, here, those parts related to resource reallocation control according to the present invention are mainly illustrated, and the other components are omitted. Hereinafter, a description will be given by taking a downlink as an example for a radio communications system.

In a resource structure diagram shown in FIG. 5, the horizontal axis shows a time direction represented by frame numbers, where it is assumed that 20 frames are equivalent to a packet transmission period. Moreover, the vertical axis shows frequency represented by resource block numbers. A system bandwidth assigned to the base station 10 is divided into small frequency bandwidths called resource blocks, and a resource block is a unit of allocation for scheduling.

In persistent scheduling PS, the resource management section 305 manages the reservation state of resource blocks as shown in FIG. 5. Note that the resource blocks are logical ones and can be different from those frequencies used when transmission is performed. This is because it is sufficient that there is a one-to-one correspondence between a logical resource block managed and a physical resource block used for transmission. Moreover, although FIG. 5 shows an example in which each transmission frame has 10 resource blocks and 20 transmission frames, this is not restrictive.

As described earlier, in persistent scheduling PS, upon arrival of a packet for which a reservation has not been made, the reservation-type scheduler 302 refers to the resource reservation state shown in FIG. 5, determines whether or not there is an unallocated resource block, and makes a reservation depending on the number of unallocated resource blocks. Once a reservation is made, it is possible to perform transmission by using the reserved resource block and transmission frame for subsequently arriving packets of the same communication.

Hereinafter, a detailed description will be given of examples of resource reallocation control at the base station 10 shown in FIG. 4. However, for convenience of description, a description will be given focusing attention on one or two frames in the resource structure shown in FIG. 5.

### 3. First Example

In resource reallocation according to a first example of the present invention, an unreserved resource in the same frame as that of a current resource is reallocated for a communication for which the number of retransmissions reaches a predetermined number of times. By newly allocating an unreserved resource in the same frame in this manner, the possibility of a reduction in reception delay is increased without changing transmission timing for this communication.

Referring to FIG. 6, in a single transmission frame (frame number k), it is assumed that resource blocks number 1 and 2 are reserved for a communication A, a resource block number 3 is reserved for a communication B, resource blocks number 4 and 5 are reserved for a communication C, and resource blocks number 6 to 10 are unreserved. Additionally, a figure shown within each resource block indicates the number of retransmissions of a packet using the resource block, and a predetermined threshold value for the number of retransmissions is assumed to be two.

In this case, since the number of retransmissions using the resource blocks number 4 and 5, which are currently used for the communication C, is not smaller than the threshold value two, the control section 306 instructs the resource reallocation section 304 to reallocate resource blocks to be used for the communication C.

The resource reallocation section 304, while referring to the resource reservation state managed by the resource management section 305, determines whether or not there are unreserved resource blocks that can be allocated to the communication C within the same frame. If there are the same number of unreserved resource blocks as the number of the resource blocks currently used for the communication C, these unreserved resource blocks are newly allocated to the communication C. In the example shown in FIG. 6, the unreserved resource blocks numbered 6 and 7 are newly allocated to the communication C, which is then notified to the resource management section 305. Thereby, the resource management section 305 makes an update such that the resource blocks numbered 6 and 7 are reserved for the communication C and that the previously used resource blocks numbered 4 and 5 are released to be unreserved. Note that although the communication C uses two resource blocks here, this is an example. Operation is similar even if the number of resource blocks is one, three or more.

### 4. Second Example

In resource reallocation according to a second example of the present invention, if the numbers of retransmissions for a plurality of communications reach a predetermined number of times and the same amounts of resources are used for these communications, then resource reallocation is performed by exchanging these resources. By exchanging resources between communications each other in this manner, it is possible to reallocate a resource even if there is no unreserved resource block. Moreover, if resources are exchanged within the same frame, the possibility of a reduction in reception delay is increased without changing transmission timing for these communications.

Referring to FIG. 7, in a single transmission frame (frame number k), it is assumed that resource blocks numbered 1 and 2 are reserved for a communication A, a resource block numbered 3 is reserved for a communication B, resource blocks numbered 4 and 5 are reserved for a communication C, resource blocks numbered 9 and 10 are reserved for a communication D, and resource blocks numbered 6 to 8 are unreserved. Additionally, as in the above-described first example, a figure shown within each resource block indicates the number of retransmissions of a packet using the resource block, and a predetermined threshold value for the number of retransmissions is assumed to be two.

In this case, the number of retransmissions using the resource blocks numbered 4 and 5, which are currently used for the communication C, is not smaller than the threshold value two. The number of retransmissions using the resource blocks numbered 9 and 10, which are currently used for the communication D, is also not smaller than the threshold value two. Accordingly, the control section 306 instructs the resource reallocation section 304 to reallocate resource blocks to be used for the communications C and D.

The resource reallocation section 304, upon finding that the communications C and D indicated as reallocation targets belong to the same frame number k and use the same number of resource blocks while referring to the resource reservation state managed by the resource management section 305, allocates the resource blocks numbered 4 and 5 used for the communication C newly to the communication D, allocates the resource blocks numbered 9 and 10 used for the communication D newly to the communication C, and then notifies it to the resource management section 305. Thereby, the resource management section 305 makes an update such that the resource blocks numbered 9 and 10 are reserved for the communication C and that the resource blocks numbered 4 and 5 are reserved for the communication D.

Note that although two communications C and D are shown here as an example, reallocation by exchanging resources can be similarly performed even for three or more communications at the same time, by exchanging resource blocks so that a different resource block is reallocated to every communication.

### 3. Third Example

In resource reallocation according to a third example of the present invention, an unreserved resource in a frame different from a frame of a current resource is reallocated for a communication for which the number of retransmissions reaches a predetermined number of times. Note that the different transmission frame is a frame subsequent to the current transmission frame. That is, in the present example, transmission timing is delayed from the current transmission frame to the subsequent transmission frame.

By newly allocating an unreserved resource in a different frame in this manner, it is possible to reallocate a resource even if there is no unreserved resource within the same frame. Moreover, since the transmission timing of a communication in question is changed, the possibility of a reduction in reception delay is further increased. Accordingly, when the number of retransmissions is not reduced even if resource reallocation is performed within the same transmission frame, the effect of reducing the number of retransmissions is expected by allocating a resource in a different frame.

Referring to FIG. 8, in a transmission frame (frame number k), it is assumed that resource blocks numbered 1 to 5 are reserved, of which the resource blocks numbered 4 and 5 are reserved for a communication C, and that resource blocks numbered 6 to 10 are unreserved. Moreover, in a different transmission frame (frame number j), it is assumed that resource blocks numbered 1 to 5 are reserved and that resource blocks numbered 6 to 10 are unreserved. Additionally, as in the first example, a figure shown within each resource block indicates the number of retransmissions of a packet using the resource block, and a predetermined threshold value for the number of retransmissions is assumed to be two.

In this case, since the number of retransmissions using the resource blocks numbered 4 and 5, which are currently used for the communication C, is not smaller than the predetermined threshold value two, the control section 306 instructs the resource reallocation section 304 to reallocate resource blocks to be used for the communication C.

The resource reallocation section 304, while referring to the resource reservation state managed by the resource management section 305, determines whether or not there are unreserved resource blocks that can be allocated to the communication C in a different frame temporally subsequently located. If there are the same number of unreserved resource blocks as the number of the resource blocks currently used for the communication C in the transmission frame j, these unreserved resource blocks are newly allocated to the communication C. In the example shown in FIG. 8, the unreserved resource blocks numbered 6 and 7 in the transmission frame j are newly allocated to the communication C, which is then notified to the resource management section 305. Thereby, the resource management section 305 makes an update such that the resource blocks numbered 6 and 7 in the transmission frame j are reserved for the communication C and that the resource blocks numbered 4 and 5 in the previous transmission frame k are released to be unreserved. Note that although the communication C uses two resource blocks here, this is an example. Operation is similar even if the number of resource blocks is one, three or more.

### 6. Fourth Example

In resource reallocation according to a fourth example of the present invention, a larger amount of unreserved resources than the amount of resources when reserved are reallocated to a communication for which the number of retransmissions reaches a predetermined number of times. For the amount of resources after reallocation, a modulation scheme and/or the coding rate of an error correction code can be changed, whereby the amount of information transmitted can be made the same as that before reallocation. For example, in a case of not changing a modulation scheme, if the coding rate of an error correction code is halved, double the amount of resources can be reallocated without changing the amount of information transmitted. In a case where a larger amount of resources are allocated in this manner, there is an effect that reception error can be greatly improved in communications with degraded communication quality.

Referring to FIG. 9, in a transmission frame (frame number k), it is assumed that resource blocks numbered 1 to 5 are reserved, of which the resource blocks numbered 4 and 5 are reserved for a communication C, and that resource blocks numbered 6 to 10 are unreserved. Additionally, as in the first example, a figure shown within each resource block indicates the number of retransmissions of a packet using the resource block, and a predetermined threshold value for the number of retransmissions is assumed to be two.

In this case, since the number of retransmissions using the resource blocks numbered 4 and 5, which are currently used for the communication C, is not smaller than the predetermined threshold value two, the control section 306 instructs the resource reallocation section 304 to reallocate resource blocks to be used for the communication C.

The resource reallocation section 304, while referring to the resource reservation state managed by the resource management section 305, determines whether or not there are unreserved resource blocks that can be allocated to the communication C within the same frame. If there are a larger number of unreserved resource blocks than the number of resource blocks currently used for the communication C, these unreserved resource blocks are newly allocated to the communication C. In the example shown in FIG. 9, the unreserved resource blocks numbered 6 to 9 are newly allocated to the communication C, which is then notified to the resource management section 305. Thereby, the resource management section 305 makes an update such that the resource blocks numbered 6 to 9 are reserved for the communication C and that the previously used resource blocks numbered 4 and 5 are released to be unreserved.

For the number of resource blocks after reallocation, a modulation scheme and/or the coding rate of an error correction code can be changed, whereby the amount of information transmitted can be kept at the same level as that before reallocation. For example, in a case of not changing a modulation scheme, if the coding rate of an error correction code is halved, four resource blocks, twice two resource blocks, can be reallocated, as shown in FIG. 9 as an example.

Note that although reallocation is performed within the same transmission frame in FIG. 9, reallocation can also be performed in a different frame as in the above-described third example. Since the number of resource blocks used for transmission is increased, a great improvement can be made on reception errors in communications with bad communication quality.

### 7. Others

In the above-described examples, although resource blocks are allocated in ascending order of resource block number when reallocation is performed, this is not restrictive. Reallocation can be applied to a resource block with any resource block number. Moreover, although a description has been given by taking a downlink as an example in the above-described second exemplary embodiment and each example, the same can also be applied to an uplink.

Further, the present invention is not only applied to LTE systems but also can be applied to radio communications systems using frequency division multiple access schemes (FDMA: Frequency Division Multiple Access).

### INDUSTRIAL APPLICABILITY

The present invention is applicable to radio communications systems and usable for, for example, radio communications systems using LTE or FDMA.

### REFERENCE SIGNS LIST

10 Base station
20 Mobile terminal
30 Upper-level network device
101 Radio communication section
102 Reservation-type scheduler
103 Retransmission frequency management section
104 Resource reallocation section
105 Resource management section
106 Control section
301 Radio communication section
302 Reservation-type scheduler
303 Retransmission frequency management section
304 Resource reallocation section
305 Resource management section
306 Control section
307 Reception processing section
308 Communication section

1. A resource reallocation method in a radio communication system in which a radio resource is reserved to periodically perform a communication between communication devices, comprising:
counting the number of retransmissions of a packet transmitted to a first communication device using a reserved radio resource; and
reallocating a radio resource for a first communication with the first communication device depending on the number of retransmissions.

2. The resource reallocation method according to claim 1, wherein when the number of retransmissions is equal to or greater than a predetermined value, a different radio resource having at least one of a different transmission timing and a different frequency from the reserved radio resource is reallocated for the first communication.

3. The resource reallocation method according to claim 2, wherein the different radio resource has the different frequency at a same transmission timing.

4. The resource reallocation method according to claim 3, wherein the different radio resource having the different frequency at a same transmission timing is an unreserved radio resource.

5. The resource reallocation method according to claim 3, wherein when the different radio resource having the different frequency at the same transmission timing is a radio resource reserved for a second communication with a second communication device, and number of retransmissions for the second communication is equal to or greater than the predetermined value, respective radio resources are exchanged between the first and the second communications.

6. The resource reallocation method according to claim 2, wherein the different radio resource has the different transmission timing.

7. The resource reallocation method according to claim 6, wherein the different radio resource having the different transmission timing is an unreserved radio resource.

8. The resource reallocation method according to claim 6, wherein when the different radio resource having the different transmission timing is a radio resource reserved for a second communication with a second device, and the number of retransmissions for the second communication is is equal to or greater than the predetermined value, respective radio resources are exchanged between the first and the second communication.

9. The resource reallocation method according to claim 5, wherein the reserved radio resource for the first communication and the reserved radio resource for the second communication have the same amount.

10. The resource reallocation method according to claim 5, wherein the reserved radio resource for the first communication and the reserved radio resource for the second communication have different amounts.

11. A communication device in a radio communication system that reserves a radio resource to periodically perform a communication with a first communication device, comprising:
a retransmission frequency measurement section configured to count the number of retransmissions of a packet transmitted to the first communication device using a reserved radio resource; and
a resource reallocation section configured to reallocate a radio resource for a first communication with the first communication device depending on the number of retransmissions.

12. The communication device according to claim 11, wherein when the number of retransmissions is equal to or greater than a predetermined value, the resource reallocation section configured to reallocate a different radio resource having at least one of a different transmission timing and a different frequency from the reserved radio resource for the first communication.

13. The communication device according to claim 12, wherein the different radio resource has the different frequency at a same transmission timing.

14. The communication device according to claim 13, wherein the different radio resource having the different frequency at the same transmission timing is an unreserved radio resource.

15. The communication device according to claim 13, wherein when the different radio resource having the different frequency at the same transmission timing is a radio resource reserved for a second communication with a second communication device, and number of retransmissions made for the second communication is equal to or greater than the predetermined value, the resource reallocation section configured to exchange respective radio resources between the first and the second communications.

16. The communication device according to claim 12, wherein the different radio resources has the different transmission timing.

17. The communication device according to claim 16, wherein the different radio resource having the different transmission timing is an unreserved radio resource.

18. The communication device according to claim 16, wherein when the radio resource having the different transmission timing is a radio resource reserved for a second communication with a second communication device, and the number of retransmissions for the second communication is is equal to or greater than the predetermined value, the resource reallocation section configured to exchange respective radio resources between the first and the second communications.

19. The communication device according to claim 15, wherein the reserved radio resource for the first communication and the reserved radio resource for the second communication have the same amount.

20. The communication device according to claim 15, wherein the reserved radio resource for the first communication and the reserved radio resource for the second communication have different amounts.

21. A base station in the radio communications system, comprising the communication device according to claim 11.

22. A radio communications system including at least one base station and at least one mobile terminal wherein a radio resource is reserved to periodically perform a communication between a base station and a mobile terminal, wherein
the base station comprises:
a retransmission frequency measurement section configured to count the number of retransmissions of a packet transmitted to a first motile terminal using a reserved radio resource; and
a resource reallocation section configured to reallocate a radio resource for a first communication with the first mobile terminal depending on the number of retransmissions.

23. The radio communications system according to claim 22, wherein when the number of retransmissions is equal to or greater than a predetermined value, the resource reallocation section configured to reallocate a different radio resource having at least one of a different transmission timing and a different frequency from the reserved radio resource for the first communication.

24. A computer readable information recording medium storing a program which, when executed by a processor in a communication device in a radio communications system that reserves a radio resource to periodically perform a communication with a first communication device, performs a method comprising:
counting the number of retransmissions of a packet transmitted to the first communication device using a reserved radio resource; and
reallocating a radio resource for a first communication with the first communication device depending on the number of retransmissions.

25. The computer readable information recording medium according to claim 24, wherein when the number of retransmissions becomes is equal to or greater than a predetermined value, a different radio resource having at least one of a different transmission timing and a different frequency from the reserved radio resource is reallocated for the first communication.
